(19) United States
(12) Patent Application Publication
(10) Pub. No.: US 2012/0192557 A1
(43) Pub. Date: Aug. 2, 2012

(54) Engine System

(75) Inventors: Steven Johnson, Brentwood (GB); Anthony Bernard Demots, London (GB); Stuart Turner, Cold Norton (GB)

(73) Assignee: FORD GLOBAL TECHNOLOGIES, LLC, Dearborn, MI (US)

(21) Appl. No.: 13/354,218

(22) Filed: Jan. 19, 2012

(30) Foreign Application Priority Data
Feb. 2, 2011 (GB) 1101797.7

(51) Int. Cl. F02B 29/04

(52) U.S. Cl. 60/599

(57) ABSTRACT

An engine system comprises an internal combustion engine, a turbocharger and an external wastegate valve. The turbocharger includes a housing for an exhaust gas turbine and a separate housing for the wastegate valve. The turbine housing is liquid cooled so as to reduce its operating temperature thereby allowing it to be made from an aluminium alloy so as to save cost and reducing, during use, the radiation of heat therefrom.

### CROSS REFERENCE TO RELATED APPLICATION

This application claims priority to United Kingdom Application No. 1101797.7, entitled “An Engine System”, filed Feb. 2, 2011, which is hereby incorporated by reference it its entirety for all purposes.

### TECHNICAL FIELD

This present disclosure relates to an engine system and in particular to a turbocharged internal combustion engine.

### BACKGROUND AND SUMMARY

It is well known to provide an internal combustion engine with a turbocharger to improve its power output and reduce emissions. Such turbochargers often incorporate a wastegate valve used to control the flow of exhaust gas in a bypass passage arranged in parallel to a turbine of the turbocharger so as to provide a means for preventing over-speeding of the turbocharger when the exhaust flow from the engine is too high for the turbocharger.

Such combined turbocharger and wastegate assemblies are large in size and of a complex design and must be made from a relatively expensive heat resistant material such as stainless steel in order to withstand the high temperatures imposed upon them by the exhaust gases flowing therethrough.

In addition, the heat radiation from a large object such as a combined turbocharger and wastegate assembly is considerable and this can produce undesirable heating of other components in an engine bay such as electronic control units or components made from plastic. This is a particular problem with modern passenger automobiles where engine compartment space is very limited.

It is further known from, for example, U.S. Pat. No. 6,976,359 to remotely mount the wastegate in a separate housing from the turbocharger, this has the advantage that the size and complexity of the turbocharger is reduced and the radiation from the turbocharger is likely to be lower due to the fact that not all of the exhaust gas passes through the turbocharger at all times. Nevertheless the radiation from such a turbocharger is still considerable and the cost of manufacture is relatively high due to the need to manufacture both the turbocharger housing and the wastegate housing from high temperature resistant materials.

It is an object of this present disclosure to provide an engine system having a turbocharger manufactured in a more cost effective manner.

According to the present disclosure there is provided an engine system comprising an internal combustion engine, a turbocharger arranged to receive exhaust gas from the engine and an external wastegate valve used to control a bypass exhaust flow past the turbocharger wherein the turbocharger has a liquid cooled turbine housing and the wastegate valve is located in a separate housing to the liquid cooled turbine housing.

The turbocharger may have a turbine located in the liquid cooled turbine housing and the turbine is arranged to receive the exhaust gas from the engine.

The wastegate valve housing may be a non-liquid cooled housing.

The wastegate valve may control the flow of exhaust gas through a bypass passage extending from a position upstream of the turbine to a position downstream of the turbine.

The upstream end of the bypass passage may be connected to the turbine housing upstream of the turbine.

Alternatively, the upstream end of the bypass passage is connected directly to the engine.

The engine may have a primary exhaust gas outlet arranged to flow exhaust gas to the turbine and a secondary exhaust gas outlet arranged to flow exhaust gas to the upstream end of the bypass passage.

The primary and secondary exhaust gas outlets may be formed as part of an exhaust manifold of the engine.

The exhaust manifold may be a liquid cooled exhaust manifold attached to a cylinder head.

The liquid cooled exhaust manifold may be formed as an integral part of the cylinder head of the engine.

The liquid cooled turbine housing may be made from an aluminium alloy material.

The cylinder head and the liquid cooled exhaust manifold may be made from substantially the same aluminium alloy as the turbine housing.

The engine system may further comprise a primary liquid cooling circuit for providing liquid coolant to the engine and the liquid cooled turbine housing receives a supply of liquid coolant from the primary liquid cooling circuit.

The liquid cooled turbine housing may receive a direct feed of liquid coolant from the engine via complementary ports on the engine and the turbine housing.

The engine system may further comprise a primary liquid cooling circuit for providing liquid coolant to the engine and a secondary liquid cooling system for providing liquid coolant to the liquid cooled turbine housing.

The secondary liquid cooling system may also supply liquid coolant to one or more of an engine oil cooler and a liquid to air intercooler.

According to a second aspect of the present disclosure there is provided an engine having a cylinder head and an exhaust manifold having a primary exhaust outlet and a secondary exhaust outlet wherein the primary exhaust outlet supplies exhaust gas to a turbocharger turbine and the secondary exhaust outlet supplies exhaust gas to a wastegate controlled turbocharger bypass passage.

The exhaust manifold may be a liquid cooled manifold.

The liquid cooled exhaust manifold may be formed as an integral part of the cylinder head.

According to a third aspect of the present disclosure there is provided a method for reducing the cost of manufacture of an engine system comprising an engine, a turbocharger having a turbine and a wastegate valve wherein the method comprises using separate housings for the turbine and the wastegate valve, liquid cooling the turbine housing and manufacturing the turbine housing from an aluminium alloy.

The engine may have an aluminium alloy cylinder head and an aluminium alloy liquid cooled exhaust manifold and the method may further comprise manufacturing the cylinder head, the liquid cooled exhaust manifold and the turbine housing from substantially the same aluminium alloy.

The engine may have a combined exhaust gas manifold and cylinder head made from an aluminium alloy and the method may further comprise manufacturing the combined exhaust gas manifold and cylinder head and the turbine housing from substantially the same aluminium alloy.

The present disclosure will now be described by way of example with reference to the following drawings.

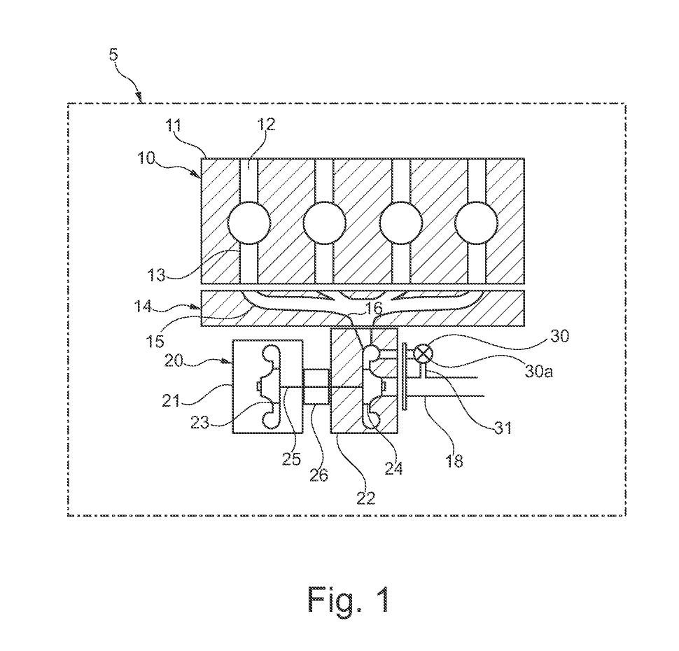

FIG. 1 shows a schematic drawing of part of an engine system according to a first embodiment of the present disclosure.

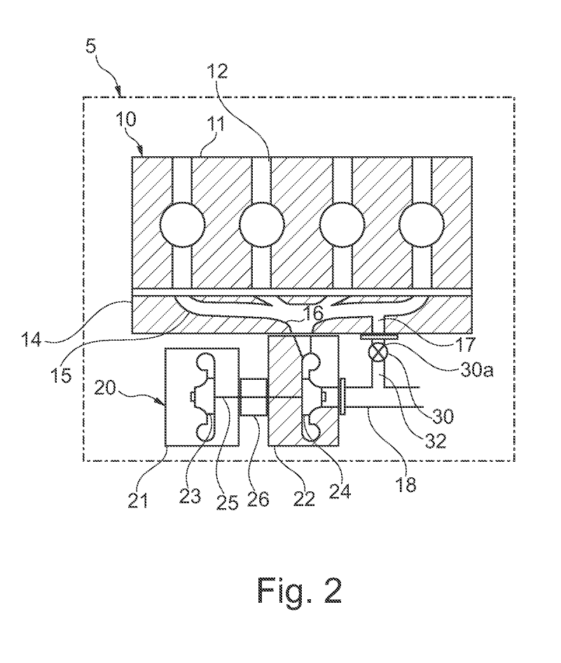

FIG. 2 shows a schematic diagram of part of an engine system according to a second embodiment of the present disclosure.

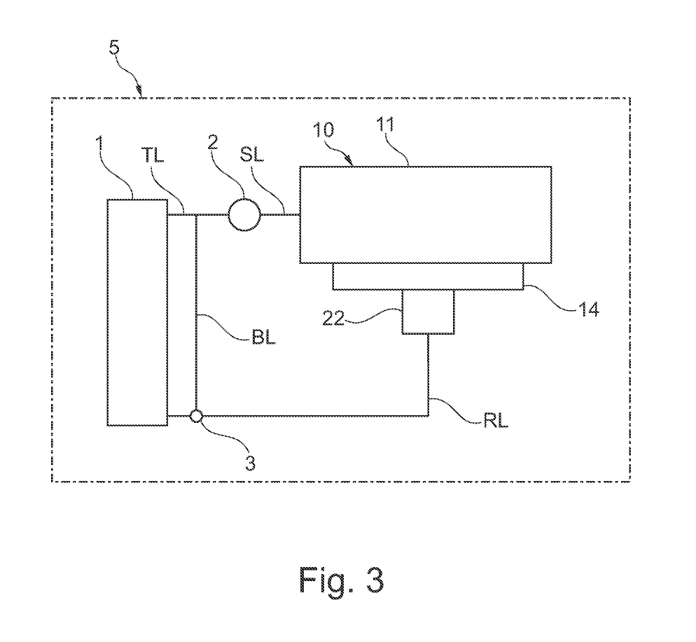

FIG. 3 shows a schematic diagram of a first embodiment of a liquid cooling circuit forming part of the engine system shown in FIGS. 1 and 2.

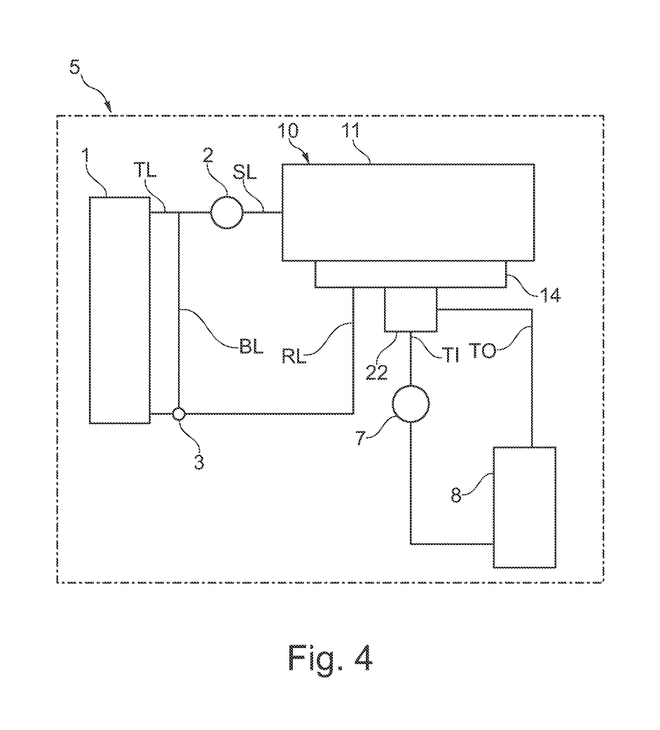

FIG. 4 shows a schematic diagram of a second embodiment of a liquid cooling circuit forming part of the engine system shown in FIGS. 1 and 2.

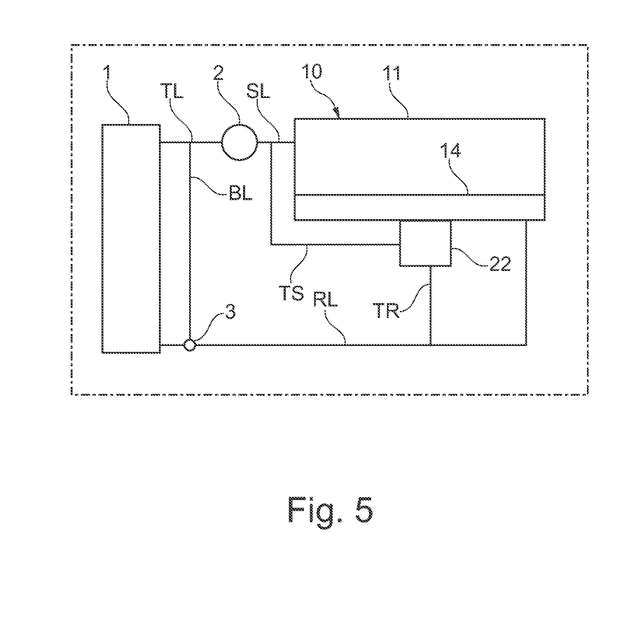

FIG. 5 shows a schematic diagram of a third embodiment of a liquid cooling circuit forming part of the engine system shown in FIGS. 1 and 2.

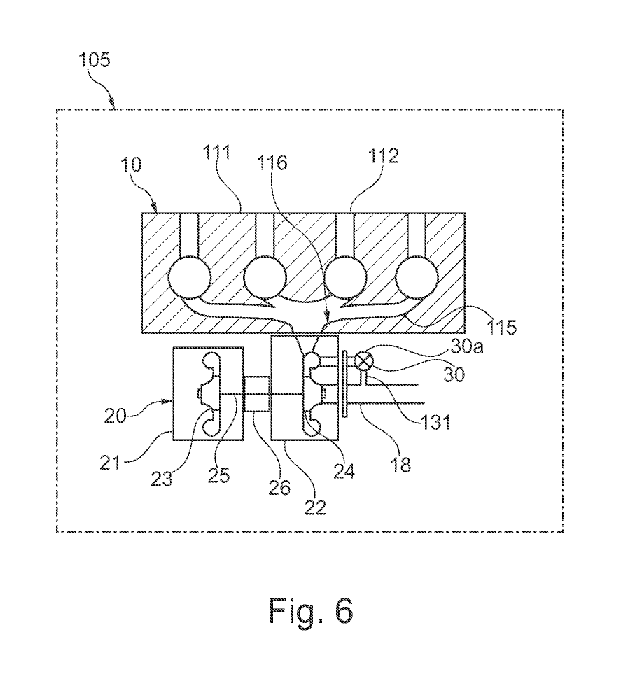

FIG. 6 shows a schematic drawing of part of an engine system according to a third embodiment of the present disclosure.

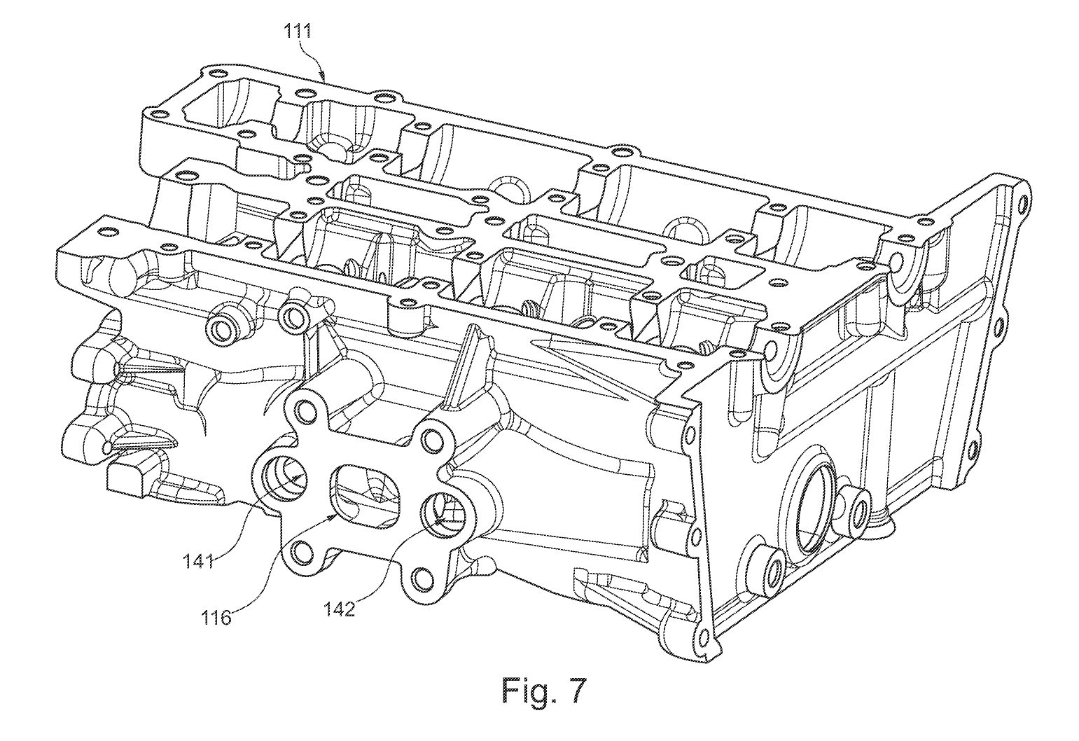

FIG. 7 shows a pictorial view of a combined cylinder head and exhaust gas manifold forming part of the engine system shown in FIG. 6, where FIG. 7 is drawn approximately to scale.

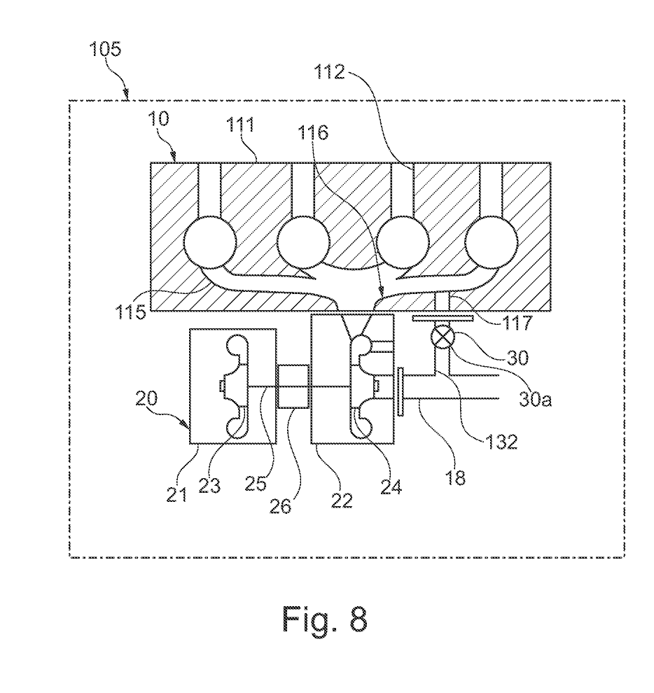

FIG. 8 shows a schematic drawing of part of an engine system according to a fourth embodiment of the present disclosure.

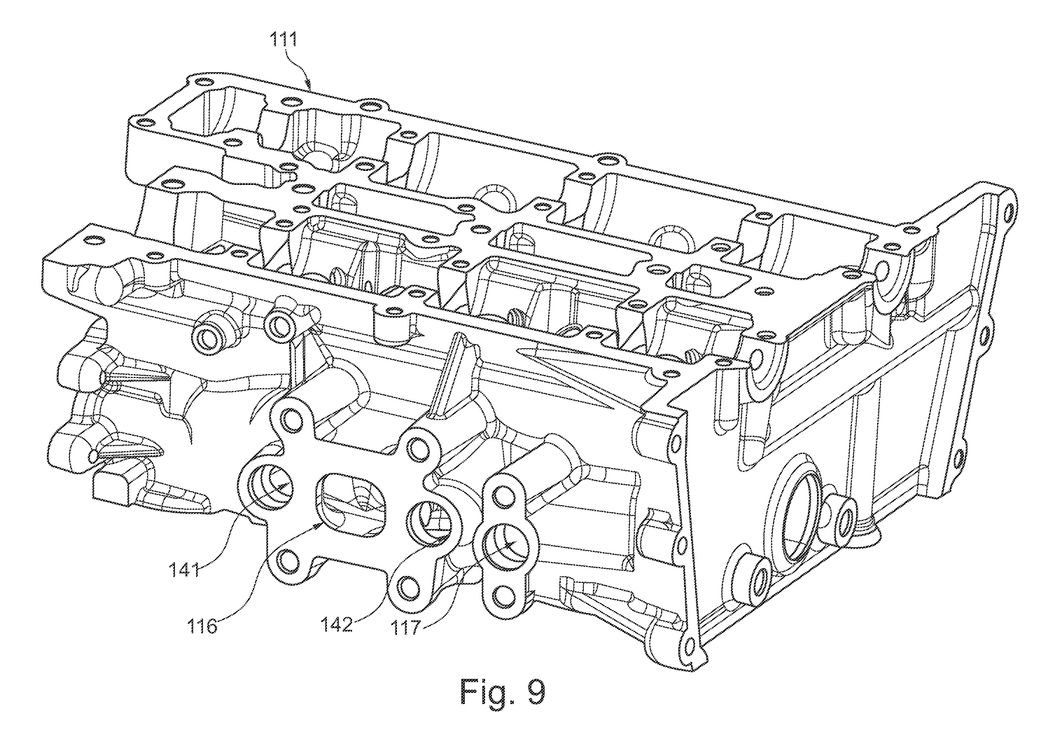

FIG. 9 shows a pictorial view of a combined cylinder head and exhaust gas manifold forming part of the engine system shown in FIG. 8.

### DETAILED DESCRIPTION

With particular reference to FIG. 1 there is shown part of an engine system 5. The engine system 5 includes an internal combustion engine 10 having a cylinder block (not shown), a liquid cooled cylinder head 11, a liquid cooled exhaust manifold 14, a turbocharger 20 and a wastegate valve 30.

The turbocharger 20 comprises a compressor housing 21 housing a compressor 23, a liquid cooled turbine housing 22 housing a turbine 24, a drive shaft 25 connecting the compressor 23 to the turbine 24 and support bearings 26 used to support the drive shaft 25. It will be appreciated that the compressor housing 21 and the liquid cooled turbine housing 22 could be formed as part of a single housing or could be formed as separate housings that are fastened to one another. In either case, liquid cooling is provided to at least the turbine housing 22 in order to cool it and allow the use of a less temperature resistant material than would otherwise be required if no cooling is provided. In one preferred embodiment of the present disclosure the liquid cooled turbine housing 22 is made from an aluminium alloy material that is of relatively low cost and can be manufactured at low cost compared to a conventional high temperature resistant housing. In one embodiment of the present disclosure the cylinder head 11, the exhaust manifold 14 and the turbine housing 22 are all made from substantially the same aluminium alloy material so as to minimize thermal stresses between the various components.

Air enters the engine 10 through a number of inlet ports 12 and exits the engine 10 via a number of exhaust ports 13 which co-operate with an exhaust gas flow passage 15 formed in the liquid cooled manifold 14. The liquid cooled manifold 14 has a primary exhaust gas outlet 16 which communicates with the turbocharger 20 so that exhaust gasses can flow from the exhaust gas flow passage 15 into the turbocharger 20 or more specifically into the liquid cooled turbine housing 22 so as to rotate the turbine 24. It will be appreciated that rotation of the turbine 24 will produce a corresponding rotation of the compressor 23 and that this rotation of the compressor 23 will then provide air at increased pressure to the inlet ports 12 via a conventional air inlet system (not shown).

The liquid cooled turbine housing 22 defines not only a working chamber for the turbine 24 but also a secondary exhaust supply passage to which is connected a first end of a bypass passage 31. A second end of the bypass passage 31 is connected to an exhaust pipe 18 used for flowing exhaust gas from the turbine 24 to atmosphere. It will be appreciated that the flow of exhaust gas to atmosphere will normally be via various exhaust gas emission treatment devices (not shown). The bypass passage 31 therefore has its first end connected upstream from the turbine 24 and its second end connected downstream from the turbine 24 so as to provide an exhaust flow path that is parallel to that past the turbine 24.

The exhaust gas flow through the bypass passage 31 is controlled by the wastegate valve 30 which has a separate housing 30a to the housing or housings used for the turbocharger 20. The construction of the wastegate valve 30 can be of any known type and is provided to selectively control the flow of exhaust gas through the bypass passage 31 in order to prevent over speeding of the turbocharger 20 when the exhaust gas flow from the engine 10 is higher than can be accommodated by the turbine 24, to regulate the output pressure generated by the compressor 23 of the turbocharger 20 or is opened during part load conditions which are the prevalent operating state for many engines in order to reduce backpressure thereby improving fuel economy. It will be appreciated that the wastegate valve housing 30a can be of a very simple design and is relatively compact and so the cost of manufacture is still relatively low even though a material able to absorb the temperature of the exhaust gas must be used. For example, in one non limiting embodiment, the wastegate valve housing 30a is in the form of a stainless steel tube having flanges at opposite ends. Alternatively, the wastegate housing could be formed as an integral part of the bypass passage.

Therefore when the wastegate valve 30 is closed all of the exhaust gas exiting the engine 10 passes by the turbine 24 and as the wastegate valve 30 is opened less exhaust gas flows past the turbine 24 until, when the wastegate valve 30 is fully open, a significant percentage of the exhaust gases exiting the engine 10 bypass the turbine 24 and flow directly to the exhaust pipe 18 via the bypass passage 31.

For example, at maximum exhaust gas flow from the engine with the wastegate valve fully open, approximately one third of the total exhaust gas flow is via the bypass passage 31.

Therefore less heat will be transferred to the liquid cooled turbine housing 22 from the exhaust gas compared to a conventional arrangement where the bypass passage is formed as part of the turbocharger.

As referred to above the turbine housing 22 is liquid cooled and includes coolant flow passages (not shown) through which liquid coolant such as, for example and without limitation, a water/glycol mixture can flow. FIGS. 3 to 5 show three alternative liquid cooling circuits forming part of the engine system 5.

In a first embodiment of a cooling circuit shown in FIG. 3, coolant is circulated by a coolant pump 2 from a radiator 1 via a top hose TL and a supply hose SL to the engine 10 and in this case to the cylinder head 11 (it will be appreciated that the supply hose SL could alternatively be connected to a cylinder block (not shown) of the engine 10). The coolant from the supply hose SL flows through the cylinder block, the cylinder head 11 and the liquid cooled manifold 14 and directly from the liquid cooled manifold 14 into the turbocharger housing 22. The coolant then flows through the cooling passages in the turbine housing 22 and out of the liquid cooled turbine housing 22 via a return hose RL to the radiator 1. (It will be appreciated that there may be a separate return from a cylinder block of the engine 10 via the return hose RL). As is usual in such a cooling circuit a coolant bypass line BL controlled by a combine bypass and thermostat valve 3 connects the return hose RL and the top hose TL so as to provide a coolant flow path that is arranged in parallel to the radiator 1.

In a second embodiment of a cooling circuit shown in FIG. 4, coolant is circulated by a coolant pump 2 from a radiator 1 via a top hose TL and a supply hose SL to the engine 10 and in this case to the cylinder head 11 (it will be appreciated that the supply hose could alternatively be connected to a cylinder block (not shown) of the engine 10). The coolant from the supply hose SL flows through the cylinder block, cylinder head 11 and liquid cooled manifold 14 and from the liquid cooled manifold 14 into a return hose RL to the radiator 1. (It will be appreciated that there may be a separate return from the cylinder block of the engine 10 via the return hose RL).

As is usual in such a cooling circuit a coolant bypass line BL controlled by a combine bypass and thermostat valve 3 connects the return hose RL and the top hose TL so as to provide a coolant flow path that is arranged in parallel to the radiator 1.

The liquid cooled turbine housing 22 in this case is cooled by a secondary cooling circuit having a pump 7 and a radiator 8. The pump 7 supplies coolant to the liquid cooled turbine housing 22 via a turbine housing inlet hose TI and coolant flows from the liquid cooled turbine housing 22 to the radiator 8 via a turbine outlet hose TO. It will be appreciated that the secondary cooling circuit could be provided solely for cooling the liquid cooled turbine housing 22 or could be used for cooling one or more other engine system components such as, for example, an engine oil cooler and/or a liquid to air intercooler.

In a third embodiment of a cooling circuit shown in FIG. 5, coolant is circulated by a coolant pump 2 from a radiator 1 via a top hose TL and a supply hose SL to the engine 10 and in this case to the cylinder head 11 (it will be appreciated that the supply hose could alternatively be connected to a cylinder block (not shown) of the engine 10). The coolant from the supply hose SL flows through the cylinder block, cylinder head 11 and liquid cooled manifold 14 and from the liquid cooled manifold 14 into a return hose RL to the radiator 1. (It will be appreciated that there may be a separate return from a cylinder block of the engine 10 via the return hose RL)

As is usual in such a cooling circuit a coolant bypass line BL controlled by a combine bypass and thermostat valve 3 connects the return hose RL and the top hose TL so as to provide a coolant flow path that is arranged in parallel to the radiator 1.

The liquid cooled turbine housing 22 in this case is cooled by a supply of coolant drawn off of the main cooling circuit from a position located between the pump 2 and the engine 10 so that a cooler supply of coolant is provided than would be the case with the arrangement shown in FIG. 3. A turbine supply hose TS is used to connect the liquid cooled turbine housing 22 to the supply hose SL through which coolant flows to the liquid cooled turbine housing 22 and the coolant is returned to the main coolant circuit via a turbine return hose TR which is connected to the return hose RL from the engine 10.

It will be appreciated that FIGS. 3 to 5 show three simplified examples of cooling arrangements for the liquid cooled turbine housing and that the present disclosure is not limited to such a cooling arrangement.

Therefore by separating the wastegate housing 30a from the liquid cooled turbine housing 22 and water cooling the liquid cooled turbine housing 22, the size of the liquid cooled turbine housing 22 will be considerably reduced thereby reducing the surface area from which heat can radiate. In addition, the turbocharger housings 21 and 22 are of a less complicated design and can be made from a lower cost material such as aluminium alloy thereby reducing the cost of manufacture. Furthermore because the normally very hot liquid cooled turbine housing 22 is cooled to a much lower temperature this further reduces the heat radiation from the turbocharger 20.

One significant advantage of separating the wastegate valve housing 30a from the turbine housing 22 is that it permits only the turbine housing 22 to be liquid cooled. This is important because a considerable amount of heat is transferred to the liquid cooling system by liquid cooling a combined turbocharger and wastegate assembly. For example, and without limitation, for an engine with a 128 kW maximum rated power output approximately 70 kW of heat is rejected at full throttle into the cooling system from the engine. At the same running conditions a combined turbocharger and wastegate assembly produces an additional 27 kW of heat to be dissipated by the cooling system. This additional thermal load may require the resizing of any associated radiators with increased cost and difficulties of packaging these in the confines of an engine compartment. By separating the turbine housing from the wastegate housing and only liquid cooling the turbine housing a considerable reduction in the heat transferred to the cooling system can be obtained. This is particularly so when there is a considerable amount of bypass flow via the wastegate valve which is the prevalent operating state. In many circumstances this reduction in thermal load produced by only liquid cooling the turbine housing allows an existing cooling system to be able to cope with the additional cooling demands placed upon it by the liquid cooling of the turbine housing or reduces the additional thermal load that can be readily accommodated without extensive redesign of the engine compartment.

With particular reference to FIG. 2 there is shown part of an engine system 5 according to a second embodiment that is in most respects the same as that described above with reference to FIG. 1 and for which a liquid cooling system such as one of those shown in FIGS. 3 to 5 would also form a part.

The engine system 5 is as described above except in relation to the liquid cooled exhaust manifold 14 and the arrangement of the bypass passage 32 which, instead of being connected at its first end to the turbocharger 20, is connected directly to the liquid cooled exhaust manifold 14.

As before, the turbocharger 20 comprises of a compressor housing 21 housing a compressor 23, a liquid cooled turbine housing 22 housing a turbine 24, a drive shaft 25 connecting the compressor 23 to the turbine 24 and support bearings 26 used to support the drive shaft 25 and the compressor housing 21 and the liquid cooled turbine housing 22 can be formed as part of a single housing or be formed as separate housings that are fastened to one another. In either case, liquid cooling is provided to at least the turbine housing 22 in order to cool it and allow the use of a less temperature resistant material than would otherwise be required if no cooling is provided. In one embodiment of the present disclosure the liquid cooled turbine housing 22 is made from an aluminium alloy material that is of relatively low cost and can be manufactured at low cost compared to a conventional high temperature resistant housing. Advantageously, the cylinder head 11, the exhaust manifold 14 and the liquid cooled turbine housing 22 are all made from substantially the same aluminium alloy material so as to minimise thermal stresses between the various components.

As before, air enters the engine 10 through a number of inlet ports 12 and exits the engine 10 via a number of exhaust ports 13 which co-operate with the exhaust gas flow passage 15 formed in the liquid cooled manifold 14. The liquid cooled manifold 14 has a primary exhaust gas outlet 16 which communicates with the turbocharger 20 so that exhaust gasses can flow from the exhaust gas flow passage 15 into the liquid cooled turbine housing 22 so as to rotate the turbine 24 and a secondary exhaust gas outlet 17 which communicates directly with the first end of the bypass passage 32.

As before, the second end of the bypass passage 31 is connected to the exhaust pipe 18 used for flowing exhaust gas from the turbine 24 to atmosphere and the flow of exhaust gas to atmosphere will normally be via various exhaust gas emission treatment devices (not shown). The bypass passage 32 therefore has its first end connected upstream from the turbine 24 and its second end connected downstream from the turbine 24 so as to provide an exhaust flow path that is parallel to that past the turbine 24.

The exhaust gas flow through the bypass passage 32 is controlled by the wastegate valve 30 which, as before, has a separate housing 30a to the housing or housings used for the turbocharger 20. The construction and operation of the wastegate valve 30 is as described above and will not be described again.

As before, approximately one third of the total exhaust gas flow is via the bypass passage 31 when the wastegate valve 30 is fully open and the maximum exhaust gas flow is being achieved by the engine 10. This reduction in exhaust gas flow through the liquid cooled turbine housing 22 means that less heat will be transferred to the liquid cooled turbine housing 22 compared to a conventional arrangement where the bypass passage is formed as part of the turbocharger. Furthermore, because with this embodiment none of the exhaust gas that flows through the bypass passage 32 comes into contact with the liquid cooled turbine housing 22, the amount of heat transferred to the liquid cooled turbine housing 22 is reduced compared to the arrangement shown in FIG. 1. In addition it is possible to arrange and contour the primary and secondary exhaust gas outlets 16 and 17 such that the flow of gas into the liquid cooled turbine housing 22 and the bypass passage 32 is better defined compared to the situation in respect of the design shown in FIG. 1 where the bypass exhaust gas flow has to turn through approximately 90 degrees to enter the bypass passage 31. Therefore upstream disturbances from the turbine 24 can be reduced by using separate exhaust outlets 16, 17 from the engine 10 thereby improving turbine efficiency.

As referred to above, the turbine housing 22 is liquid cooled and includes coolant flow passages (not shown) through which liquid coolant such as, for example and without limitation, water can flow when connected to a cooling circuit such as for example one of the cooling circuits shown in FIGS. 3 to 5.

With reference to FIGS. 6 and 7 there is shown a third embodiment of an engine system 105 which is in most respects the same as that shown in FIG. 1.

The engine system 105 includes an internal combustion engine 10 having a liquid cooled combined exhaust manifold and cylinder head 111, a turbocharger 20 and a wastegate valve 30.

The turbocharger 20 is identical to that described with respect to FIG. 1 and will therefore not be described again in detail. As before, the liquid cooled turbine housing 22 is made from an aluminium alloy material that is of relatively low cost and can be manufactured at low cost compared to a conventional high temperature resistant housing. Advantageously, the combined exhaust gas manifold and cylinder head 111 and the liquid cooled turbine housing 22 are made from substantially the same aluminium alloy material so as to minimise thermal stresses between them.

Air enters the engine 10 through a number of inlet ports 112 and exits the engine 10 via an exhaust gas flow passage 115 formed as an integral part of the combined exhaust manifold and cylinder head 111. The combined exhaust gas manifold and cylinder head 111 has a primary exhaust gas outlet 116 which communicates with the turbocharger 20 so that exhaust gasses can flow from the exhaust gas flow passage 115 into the liquid cooled turbine housing 22 so as to rotate the turbine 24.

As above, the liquid cooled turbine housing 22 defines not only a working chamber for the turbine 24 but also a secondary exhaust supply passage to which is connected a first end of a bypass passage 131. A second end of the bypass passage 131 is connected to an exhaust pipe 18 used for flowing exhaust gas from the turbine 24 to atmosphere via various exhaust gas emission treatment devices (not shown). The bypass passage 131 therefore has its first end connected upstream from the turbine 24 and its second end connected downstream from the turbine 24 so as to provide an exhaust flow path that is parallel to that past the turbine 24.

As before, the flow through the bypass passage 131 is controlled by the wastegate valve 30 which has a separate housing 30a to the housing or housings used for the turbocharger 20. The construction and operation of the wastegate valve 30 is as described above.

Therefore the main difference between this embodiment and that described above with reference to FIG. 1 is that the liquid cooled manifold is in this case formed as an integral part of the cylinder head so as to form the combined exhaust gas manifold and cylinder head 111.

As referred to above the turbine housing 22 is liquid cooled and includes coolant flow passages (not shown) through which liquid coolant such as, for example and without limitation, water can flow. It will be appreciated that the three alternative liquid cooling circuits shown in FIG. 3 to 5 could be adapted to supply liquid coolant to the liquid cooled turbine housing shown in FIG. 6 so as to form part of the engine system 105.

For example, and with reference to FIGS. 3 and 7, in a case where the coolant flows directly from the engine 10 to the liquid cooled turbine housing 22, the combined exhaust manifold and cylinder head 111 has integrally formed coolant flow ports 141, 142. The ports 141, 142 are arranged in use to match up with complementary ports (not shown) located on the liquid cooled turbine housing 22 so as to provide a coolant flow connection therebetween. In use coolant flows out of port 141 through the liquid cooled turbine housing 22 and back to the combined exhaust manifold and cylinder head 111 via the port 142 and then into the cylinder block of the engine from where it is returned to the radiator 1 via the return hose RL. This has the advantage that a supply of coolant to the liquid cooled turbine housing 22 is made without the need for addition hoses or pipes.

With particular reference to FIG. 8 there is shown a fourth embodiment of an engine system 105 that is in many respects the same as that described above with reference to FIG. 2 except in relation to the liquid cooled exhaust manifold which, instead of being a separate component, is formed as an integral part of the cylinder head so as to form a combined exhaust manifold and cylinder head 111.

The turbocharger 20 is as before and will not be described again in detail and the turbine housing 22 is liquid cooled and is made from an aluminium alloy material that is of relatively low cost and can be manufactured at low cost compared to a conventional high temperature resistant housing.

Advantageously, the combined exhaust manifold and cylinder head 111 and the liquid cooled turbine housing 22 are both made from substantially the same aluminium alloy material so as to minimise thermal stresses between them.

Air enters the engine 10 through a number of inlet ports 112 and exits the engine 10 via an exhaust gas flow passage 115 formed as an integral part of the combined exhaust manifold and cylinder head 111. The combined exhaust gas manifold and cylinder head 111 has a primary exhaust gas outlet 116 which communicates with the turbocharger 20 so that exhaust gasses can flow from the exhaust gas flow passage 115 into the liquid cooled turbine housing 22 so as to rotate the turbine 24 and a secondary exhaust gas outlet 117 for communication with a first end of a bypass passage 132.

A second end of the bypass passage 132 is connected to the exhaust pipe 18 used for flowing exhaust gas from the turbine 24 to atmosphere via various exhaust gas emission treatment devices (not shown). The bypass passage 132 therefore has its first end connected upstream from the turbine 24 and its second end connected downstream from the turbine 24 so as to provide an exhaust flow path that is parallel to that past the turbine 24.

The flow through the bypass passage 132 is controlled by the wastegate valve 30 which, as before, has a separate housing 30a to the housing or housings used for the turbocharger 20. The construction and operation of the wastegate valve 30 is as described above and will not be described again.

As before, approximately one third of the total exhaust gas flow is via the bypass passage 132 when the maximum exhaust gas flow is achieved and the wastegate valve 30 is fully open. Because with this embodiment none of the exhaust gas that flows through the bypass passage 132 comes into contact with the liquid cooled turbine housing 22 the amount of heat transferred to the liquid cooled turbine housing 22 is reduced compared to the arrangement shown in FIG. 6. In addition, it is possible to arrange and contour the primary and secondary exhaust gas outlets 116 and 117 such that the flow of gas into the liquid cooled turbine housing 22 and the bypass passage 132 is better defined compared to the situation in respect of the design shown in FIG. 6 where the bypass exhaust gas flow has to turn through approximately 90 degrees to enter the bypass passage. Therefore the use of separate exhaust gas outlets 116, 117 from the combined exhaust manifold and cylinder head 111 has the effect of reducing disturbances upstream from the turbine 24, thereby improving turbine efficiency.

As referred to above, the turbine housing 22 is liquid cooled and includes coolant flow passages (not shown) through which liquid coolant such as, for example and without limitation, water can flow when connected to a cooling circuit. It will be appreciated that the cooling circuits shown in FIGS. 3 to 5 could be readily adapted to suit a combined exhaust manifold cylinder head design as shown in FIGS. 8 and 9.

For example, and with reference to FIGS. 3 and 9, in the case where the coolant flows directly from the engine 10 to the liquid cooled turbine housing 22, the combined exhaust manifold and cylinder head 111 has integrally formed coolant flow ports 141, 142 as shown on FIG. 9. The ports 141, 142 are arranged in use to match up with complementary ports (not shown) located on the liquid cooled turbine housing 22 so as to provide a coolant flow connection therebetween. In use coolant flows out of port 141 through the liquid cooled turbine housing 22 and back to the combined exhaust manifold and cylinder head via the port 142. This has the advantage that a supply of coolant to the liquid cooled turbine housing 22 is made without the need for addition hoses or pipes.

Therefore in summary, by separating a wastegate valve and its housing from a turbocharger and liquid cooling a turbine housing forming part of the turbocharger a more compact turbocharger is produced with a much lower radiant heating effect. In addition, because much of the exhaust gas flows through the wastegate valve during certain operating conditions of the engine, the amount of heat transferred to the turbine housing is reduced if an external wastegate is used. The use of an external non-liquid cooled wastegate valve housing also reduces the additional thermal load that has to be accommodated by the liquid cooling system used to cool the turbine housing compared to the situation where the wastegate valve housing is formed as part of the turbocharger and is also liquid cooled.

Furthermore, the liquid cooling of the turbine housing allows the use of less expensive materials to be used for its manufacture due to the lower temperatures that the turbine housing material has to withstand.

It will be appreciated by those skilled in the art that although the present disclosure has been described by way of example with reference to one or more embodiments it is not limited to the disclosed embodiments and that one or more modifications to the disclosed embodiments or alternative embodiments could be constructed without departing from the scope of the present disclosure as set out in the appended claims.

1. A system comprising:
an engine; and
a turbocharger having a turbine receiving exhaust gas from an engine exhaust manifold and an external wastegate valve controlling a bypass exhaust flow past the turbocharger, the turbocharger within a liquid cooled turbine housing with the turbine located in the housing and the wastegate valve located in a separate non-liquid cooled housing to the liquid cooled turbine housing.

2. The system of claim 1 wherein the engine has a cylinder head and the exhaust manifold is a liquid cooled exhaust manifold attached to the cylinder head.

3. The system of claim 1 wherein the engine has a cylinder head and the exhaust manifold is a liquid cooled exhaust manifold positioned and integrated within the cylinder head.

4. The system of claim 3 wherein the liquid cooled turbine housing comprises an aluminium alloy material and the cylinder head and the liquid cooled exhaust manifold comprise the same aluminium alloy as the turbine housing.

5. The system of claim 3 wherein the wastegate valve controls the flow of exhaust gas through a bypass passage extending from a position upstream of the turbine to a position downstream of the turbine and an upstream end of the bypass passage is connected to the turbine housing upstream of the turbine.

6. The system of claim 3 wherein the exhaust manifold has a primary exhaust gas outlet arranged to flow exhaust gas to the turbine and a secondary exhaust gas outlet arranged to flow exhaust gas to an upstream end of a bypass passage extending from a position upstream of the turbine to a position downstream of the turbine.

7. The system of claim 6 wherein the wastegate valve controls the flow of exhaust gas through the bypass passage and the upstream end of the bypass passage is connected to the secondary exhaust gas outlet.

8. The system of claim 7 wherein the system further comprises a primary liquid cooling circuit for providing liquid coolant to the engine and the liquid cooled turbine housing receives a supply of liquid coolant from the primary liquid cooling circuit.

9. The system of claim 8 wherein the liquid cooled turbine housing receives a direct feed of liquid coolant from the engine via complementary ports on the engine and the turbine housing.

10. The system of claim 7 wherein the system further comprises a primary liquid cooling circuit for providing liquid coolant to the engine and a secondary liquid cooling system for providing liquid coolant to the liquid cooled turbine housing.

11. The system of claim 10 wherein the secondary liquid cooling system also supplies liquid coolant to one or more of an engine oil cooler and a liquid to air intercooler.

12. An system comprising:
an engine;
a turbocharger having a turbine receiving exhaust gas from an engine exhaust manifold positioned in a cylinder head, the turbocharger positioned within a liquid cooled turbine housing coupled to the cylinder head; and
an external wastegate valve controlling a bypass exhaust flow past the turbocharger, the wastegate valve located in a non-liquid cooled housing separate from the turbine housing, the separate housing coupled to the cylinder head.

13. The system of claim 12 wherein the separate housing is coupled to the cylinder head at a position spaced away from the coupling of the turbocharger housing to the cylinder head.

14. The system of claim 14 wherein the cylinder head and turbine share a liquid coolant loop, the loop not flowing through the separate housing.

15. The system of claim 14 wherein the engine is a direct fuel injection engine with fuel injectors directly injecting fuel into cylinders of the engine.
